(19) United States
(12) Patent Application Publication
(10) Pub. No.: US 2018/0138780 A1
(43) Pub. Date: May 17, 2018

(54) Electric Machine and Apparatus Comprising the Same

(71) Applicant: NovoMoto Limited, Hong Kong (CN)

(72) Inventor: Kwok Pun HO, Hong Kong (CN)

(21) Appl. No.: 15/494,736

(22) Filed: Apr. 24, 2017

(30) Foreign Application Priority Data
Nov. 11, 2016 (CN) 201610994724.1

(51) Int. Cl. H02K 7/08

(52) U.S. Cl. CPC H02K 7/088

(57) ABSTRACT

An electric machine includes: a stator component; a rotor component, wherein a gap is formed between the stator component and the rotor component; and a bushing layer disposed between opposite surfaces of the stator component and the rotor component and configured to define the gap, wherein a thickness of the bushing layer is less than the gap.

### RELATED APPLICATIONS

This application claims priority under 35 U.S.C. § 119 to Chinese Patent Application No. 201610994724.1, filed on Nov. 11, 2016. The entire content of which is incorporated herein in its entirety.

### FIELD OF THE INVENTION

The present disclosure relates to an electric machine technical field, and particularly relates to an electric machine and an apparatus comprising the electric machine.

### BACKGROUND OF THE INVENTION

In the electric machine technical field, the electric machine can include an electric motor configured to output power and a generator configured to generate electricity. In some cases, the electric motor and the generator can be implemented by using a same configuration, wherein functions of the electric motor and the generator can be achieved by applying different electrical connection manners and different mechanical connection manners to the same configuration.

FIG. 5 is an axial sectional schematic diagram of a rotational electric machine in the prior art. As shown in FIG. 5, the electric machine includes a rotor 20′ and a stator 10′, wherein the stator 10′ is stationary and the rotor 20′ is movable. There is a gap between the stator 10′ and the rotor 20′ due to different designed radii (the gap refers to a distance between opposite surfaces of the stator 10′ and the rotor 20′), so that an air gap 30′ is formed between the opposite surfaces of the stator 10′ and the rotor 20′ (the air gap refers to a vacant space between the opposite surfaces of the stator 10′ and the rotor 20′). A magnetic gap is formed by the gap between the stator 10′ and the rotor 20′ by providing a permanent magnet or an exciting winding on the stator and/or the rotor, which prevents the gap from changing its consistency during movement of the rotor, such as deflection of the rotor. Therefore, the gap between the stator and the rotor is defined by bearings 40 at two ends of the stator 10′ and the rotor 20′ of the electric machine, which can prevent size of the gap between them from changing its consistency during movement of the rotor. The stator 10′, the rotor 20′ and the bearings 40 can be fixed in the axial direction by providing end covers 51, 52 at two ends of the stator 10′ and the rotor 20′.

Disadvantage that the gap between the stator and the rotor is defined by the bearings at two ends of the stator and the rotor is that: on the one hand, the bearings have larger weights; on the other hand, only the gap of 0.5-1 mm between the stator and the rotor can be defined by the bearings configuration. When a less gap between the stator and the rotor needs to be defined, it is hard to ensure accuracy of the gap. Therefore, other mechanical structures have to be added to ensure the position accuracy of the bearings. Because the bearings have larger weights and other auxiliary mechanical structures are added, the whole electric machine has a more complex structure and the weight thereof is increased.

### SUMMARY OF THE INVENTION

Accordingly, it is necessary to provide an electric machine and an apparatus including the electric machine, wherein a bushing layer is disposed between opposite surfaces of the stator component and the rotor component and configured to define the gap, wherein a thickness of the bushing layer is less than the gap, which ensures movement of the rotor component with respect to the stator component, so that the gap between the stator component and the rotor component can be defined by a simple structure of the electric machine, which reduces weight of the electric machine.

An electric machine includes: a stator component; a rotor component, wherein a gap is formed between the stator component and the rotor component; and a bushing layer disposed between opposite surfaces of the stator component and the rotor component and configured to define the gap, wherein a thickness of the bushing layer is less than the gap.

An apparatus includes: an electric machine including: a stator component; a rotor component, wherein a gap is formed between the stator component and the rotor component; and a bushing layer disposed between opposite surfaces of the stator component and the rotor component and configured to define the gap, wherein a thickness of the bushing layer is less than the gap.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

These and other features of the present disclosure will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure.

FIG. 1 shows a schematic diagram of an electric machine in an embodiment;

FIG. 2 shows a schematic diagram of a rotational electric machine in an embodiment, wherein the integral axial sectional schematic diagram of the electric machine is shown at the left side, and the enlarged schematic diagram of partial A is shown at the right side;

FIG. 3 shows a schematic diagram of another rotational electric machine in an embodiment, wherein the integral axial sectional schematic diagram of the electric machine is shown at the left side, and the enlarged schematic diagram of partial A′ is shown at the right side;

FIG. 4 shows a schematic diagram of yet another rotational electric machine in an embodiment, wherein the integral axial sectional schematic diagram of the electric machine is shown at the left side, and the enlarged schematic diagram of partial A″ is shown at the right side; and

FIG. 5 shows an axial sectional schematic diagram of the electric machine in the prior art.

### DETAILED DESCRIPTION OF THE EMBODIMENTS

Embodiments of the disclosure are described more fully hereinafter with reference to the accompanying drawings, in which preferred embodiments of the disclosure are shown. The various embodiments of the disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. Herein terms used in the specification of the disclosure aim at describing the specific embodiments without limiting the disclosure. Terms “and/or” used herein comprise any and all combination of one or more related item listed.

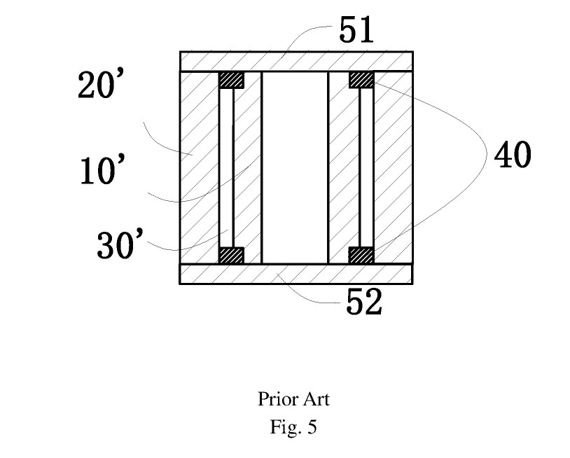

FIG. 1 shows a schematic diagram of an electric machine in an embodiment; FIG. 5 shows an axial sectional schematic diagram of the electric machine in the prior art.

The electric machine described in the present disclosure can include an electric motor configured to convert the electrical energy into the kinetic energy and output the kinetic energy, and a generator configured to convert the kinetic energy into the electrical energy and output the electrical energy. In some cases, the electric motor and the generator can be implemented by using a same configuration, wherein functions of the electric motor and the generator can be achieved by applying different electrical connection manners and different mechanical connection manners to the same configuration. The electric machine can include a linear electric machine performing a linear movement and a rotational electric machine performing a rotational movement. The electric machine includes a stator component and a rotor component. It is called a stator because the stator is stationary with respect to the rotor. In the electric machine, according to the electromagnetic induction principle, there is a gap between the stator component and the rotor component to form a magnetic gap. Movement of the rotor component is achieved by cooperation of the stator component and the rotor component.

As shown in FIG. 5, according to description in the background, the electric machine includes a rotor 20′ and a stator 10′. There is a gap between the stator 10′ and the rotor 20′, so that an air gap 30′ is formed between the opposite surfaces of the stator 10′ and the rotor 20′. Currently, the gap between the stator 10′ and the rotor 20′ is defined by the bearings 40 at two ends of the stator 10′ and the rotor 20′. Disadvantage that the gap between the stator and the rotor is defined at two ends is that: on the one hand, the bearings 40 have larger weights; on the other hand, only the gap of 0.5-1 mm between the stator 10′ and the rotor 20′ can be defined by the bearings 40. When a less gap between the stator and the rotor needs to be defined, it is hard to ensure accuracy of the gap. Therefore, other mechanical structures have to be added to ensure the position of the bearings. Because the bearings have larger weights and other auxiliary mechanical structures are added, the whole electric machine has a more complex structure and the weight thereof is increased.

As shown in FIG. 1, in order to solve the above problems, the electric machine provided by the present disclosure includes a bushing layer 30 disposed between opposite surfaces of the stator component 10 and the rotor component 20 and configured to define the gap, wherein a thickness of the bushing layer 30 is slightly less than the gap.

Because the thickness of the bushing layer is slightly less than the gap, it can be ensure the bushing layer defines the gap between the stator component and the rotor component, and movement of the rotor component with respect to the stator component will not be influenced. Although the bushing layer is disposed between opposite surfaces of the stator component and the rotor component, the air gap between opposite surfaces of the stator component and the rotor component is filled partially (such as more than half of the air gap) or completely by the bushing layer, formation of the magnetic gap therebetween will not be influenced as long as there is a gap between the stator component and the rotor component.

It should be illustrated that the bushing layer is disposed between opposite surfaces of the stator component and the rotor component, and can be fixed to the corresponding stator component or the corresponding rotor component, which ensures the bushing layer is at least fixed on the stator component or the rotor component. Therefore, friction of the stator component or the rotor component with the respective side surface of the corresponding fixed bushing layer can be relatively reduced during movement of the rotor. In addition, the bushing layer cannot be fixed on the stator component or the rotor component. That is to say, the bushing layer can be only disposed in the air gap between the stator component or the rotor component which is feasible because the thickness of the bushing layer is slightly less than the gap but which may relatively increase friction during movement of the rotor component.

It should be illustrated that the thickness is 0.01 mm-0.02 mm less than the gap, but it is not limited to this. Difference between the gap and the thickness can vary with structure of the electric machine as long as the bushing layer can define the gap between the stator component and the rotor component and movement of the rotor component with respect to the stator component will not be influenced. Compared with the manner of disposing the bearings at two ends, the manner of the present disclosure can define the gap of 0.1 mm-0.15 mm between the stator component and the rotor component by the simple structure.

Because in the electric machine a bushing layer of a thickness slightly less than the gap is disposed between opposite surfaces of the stator component and the rotor component, the gap between the stator component and the rotor component can be defined while ensuring movement of the rotor component with respect to the stator component and not influencing formation of the magnetic gap between the stator component and the rotor component. Therefore, in the electric machine, the gap between the stator component and the rotor component can be defined by a simple structure, which reducing the weight of the electric machine; meanwhile, by using the simple structure, a very little gap between the stator component and the rotor component can be defined without adding other members, so that even if the present disclosure is applied to the electric machine of a little gap, the weight of the electric machine can be reduced.

Further, in some electric machine (such as the electric motor in which surfaces of the stator component and the rotor component are provided with a slot structure), the torque can be increased by increasing the number of slots and correspondingly decreasing the gap between the stator component and the rotor component, which can replace the reducer (the disadvantage of which is a higher cost, a larger weight, not wear-resisting and the like) to increase the torque to an extent in some cases, and then disadvantages of using the reducer can be overcome.

The bushing layers of various shapes, structures and numbers can be disposed between opposite surfaces of the stator component and the rotor component, as long as the bushing layers disposed between opposite surfaces of the stator component and the rotor component can not only define the gap between the stator component and the rotor component, but also ensure movement of the rotor component with respect to the stator component, which belongs to the protective scope of the present disclosure. The bushing layers will be illustrated in detail by some embodiments in the following. However, it should be illustrated that the shapes, structures and numbers of the bushing layers are not limited to these listed embodiment.

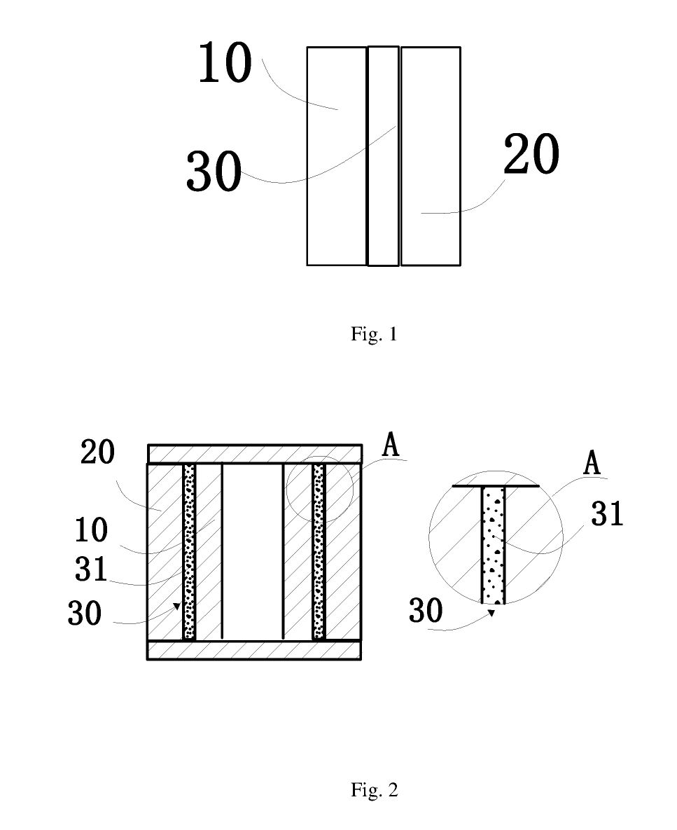

FIG. 2 shows a schematic diagram of a rotational electric machine in an embodiment, wherein the integral axial sectional schematic diagram of the electric machine is shown at the left side, and the enlarged schematic diagram of partial A is shown at the right side.

As shown in FIG. 2, in some embodiments, the bushing layer is an integral first bushing 31, and two side surfaces of the first bushing 31 correspond to the stator component 10 and the rotor component 20 respectively.

The shape of the first bushing 31 corresponds to the shape of the air gap between opposite surfaces of the stator component and the rotor component. When the electric machine is a rotational electric machine, the air gap between the stator component and the rotor component is of a cylinder or a circular ring, and then the first bushing 31 can be of a cylinder or a circular ring; when the electric machine is a linear electric machine, the air gap is formed as a plane, and then the first bushing is of a plane. The first bushing can be a structure completely filled in the air gap between opposite surfaces of the stator component and the rotor component as shown in FIG. 1, that is to say, the shape of the first bushing completely corresponds to the air gap, except for the thickness of the first bushing being slightly less than the gap; in addition, the first bushing can be a structure partially filled in the air gap (such as the height of the first bushing is less than the air gap) and the like, as long as the thickness of the first bushing is slightly less than the gap and the first bushing can completely or partially fill in the air gap, which belongs to the protective scope of the present disclosure.

In further embodiments, the first bushing 31 have two side surfaces corresponding to the stator component 10 and the rotor component 20 respectively, wherein a side surface is fixed to the corresponding stator component 10 or the corresponding rotor component 20, which ensures the first bushing 31 is at least fixed on the stator component 10 and the rotor component 20. Therefore, friction of the stator component or the rotor component with the respective side surface of the corresponding fixed bushing layer can be relatively reduced during movement of the rotor.

In addition to the above embodiments, two side surfaces of the first bushing can not be fixed to the stator component and the rotor component, that is to say, the bushing layer is only inserted in the air gap between the stator component and the rotor component, which is also feasible because the thickness of the first bushing is slightly less than the air gap, but by which friction during movement of the rotor component will be increased.

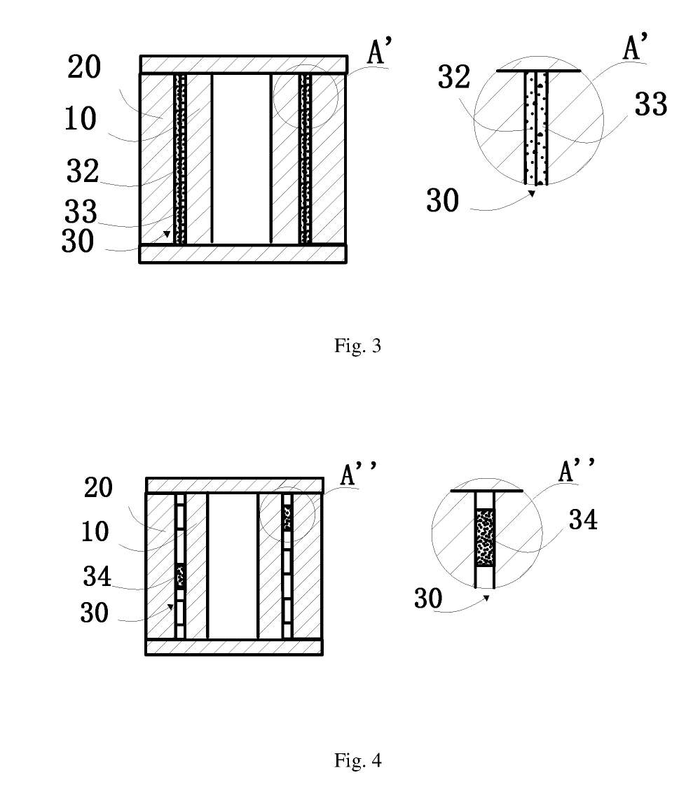

FIG. 3 shows a schematic diagram of another rotational electric machine in an embodiment, wherein the integral axial sectional schematic diagram of the electric machine is shown at the left side, and the enlarged schematic diagram of partial A′ is shown at the right side.

As shown in FIG. 3, in another embodiment, the bushing layer includes two second bushings 32, 33 radially arranged in the air gap in parallel.

The bushing layer is formed by radially overlapped two second bushings arranged in the air gap in parallel, and thicknesses of the two second bushings can be same or different, as long as the thickness of the overlapped two second bushings is slightly less than the gap between the stator component and the rotor component. The shapes of the two second bushings vary with the shape of the air gap between the stator component and the rotor component of the electric machine. When the electric machine is a rotational electric machine, the air gap between the stator component 10 and the rotor component 20 is of a cylinder or a circular ring, and then the second bushings 32, 33 can be of a cylinder or a circular ring; when the electric machine is a linear electric machine, the air gap between the stator component and the rotor component is formed as a plane, and then the second bushings 32, 33 are of a plane. The two second bushings 32, 33 can be structures completely filled in the air gap as shown in FIG. 2, that is to say, the shapes thereof completely correspond to the air gap, except for the thicknesses thereof being slightly less than the gap; in addition, the two second bushings can be structures partially filled in the air gap (such as the heights thereof is less than the air gap) and the like, as long as the thicknesses of the two second bushings are slightly less than the gap and the second bushings can completely or partially fill in the air gap, which belongs to the protective scope of the present disclosure.

The two second bushings 32, 33 have side surfaces opposite to each other, and other side surfaces thereof correspond to the stator component 10 and the rotor component 20 respectively. In an embodiment, side surfaces of the two second bushings 32, 33 respectively corresponding to the stator component 10 and the rotor component 20 are fixed to the corresponding stator component 10 and the corresponding rotor component 20 respectively.

In addition to the above embodiments, two side surfaces of the two second bushings 32, 33 respectively corresponding to the stator component 10 and the rotor component 20 can not be fixed to the stator component 10 and the rotor component 20, that is to say, the second bushings 32, 33 are only inserted in the air gap between the stator component 10 and the rotor component 20, which is also feasible because the thickness of the bushing layer is slightly less than the air gap, but by which friction between the bushing layer and the stator component and the rotor component during movement of the rotor component will be relatively increased.

It should be illustrated that the number of the second bushings is not limited to two as shown in FIG. 3, and can be more than two (not shown in Figure). In an embodiment, the two second bushings located at two ends are fixed to the corresponding stator component and the corresponding rotor component respectively. In addition to the above embodiments, two side surfaces of the two second bushings located at two ends are not fixed to the stator component and the rotor component, that is to say, the second bushings are only inserted in the air gap between the stator component and the rotor component, which is also feasible because the thickness of the second bushing is slightly less than the air gap, but by which friction during movement of the rotor component will be relatively increased.

FIG. 4 shows a schematic diagram of yet another rotational electric machine in an embodiment, wherein the integral axial sectional schematic diagram of the electric machine is shown at the left side, and the enlarged schematic diagram of partial A″ is shown at the right side.

As shown in FIG. 4, in another embodiment, the bushing layer includes at least two third bushings 34 distributed in the air gap. The third bushing 34 includes at least two structures of same thickness and any shapes such as a bulk, a ring and the like, for example the third bushing 34 can include a plurality of bulk structures scattered in the air gap (as shown in FIG. 4). The bulk structure can be of a plane (such as applied in the linear electric machine), or an arc surface (such as applied in the rotational electric machine); or when the electric machine is a rotational electric machine, the third bushing is a plurality of a circular ring or a cylinder corresponding to and in parallel disposed with the cylinder or the circular ring enclosed by the air gap. Each of the third bushings can be of same or different shapes, as long as the thickness of the bushing layer is slightly less than the gap and the third bushings can completely or partially filled in the air gap as a whole, which belongs to the protective scope of the present disclosure.

A side surface of each third bushing 34 is fixed to the corresponding stator component 10 or the rotor component 20, which ensures the third bushing 34 is at least fixed on the stator component 10 or the rotor component 20. Therefore, friction of the rotor component 20 and the side surface fixed to the bushing layer during movement of the rotor component 20 is relatively reduced.

In addition to the above embodiments, two side surfaces of each third bushings 34 can not be fixed to the stator component 10 and the rotor component 20, that is to say, the third bushings are only inserted in the air gap, which is also feasible because the thickness of the third bushings is slightly less than the gap, but by which friction during movement of the rotor component will be relatively increased.

It should be illustrated that the bushing layer, the first bushing, the second bushing and the third bushing included by the bushing layer can be made of at least one selected from the group consisting of Teflon, epoxy resin, nickel, or any material a surface of which is coated with epoxy resin; or a material such as the relevant metal or alloy directly electroplated on the rotor component and/or the rotor component and the like, such as copper; or combination of the above materials, such as combination of Teflon and epoxy resin and the like.

The above materials have the following advantages: a light weight, resistant to friction, a smooth surface. Therefore, with respect to the bearings, the bushing layer made of these materials can relatively reduce wearing and friction during movement between the rotor and the stator, and reduce the weight of the electric motor. It should be illustrated that the bushing layer, the first bushing, the second bushing and the third bushing is not limited to be made of the above materials. In principle, the bushing layer can be made of any material.

The fixation manner includes but not limited to: adhesion, electroplating or a snap-fit connection or a fixing member (such as a screw). In an embodiment, the fixation manner is selected as adhesion or electroplating.

The present disclosure further provides an apparatus (not shown) including the above electric machine.

The apparatus can be any apparatus including the above electric machine.

The apparatus is, but not limited to, a robot directly driven by the electric machine, particularly, an industrial robot. At present, the electric machine which directly drives the robot generally needs to bear a larger load, and then it needs to increase the torque output by the electric machine. However, the method applied in the robot of increasing the torque is generally implemented by reducing the speed, but the reducer has disadvantages of a larger weight, a higher cost, a easier loss and the like. On the contrast, in the electric machine provided by the present disclosure, on the one hand, a very little gap between the stator component and the rotor component of the electric machine can be implemented by a simple structure, which reducing the weight of the electric machine; on the other hand, because the gap has been reduced, the torque can be increased correspondingly in some electric machine structures. Therefore, the solution provided the present disclosure can replace the reducer (disadvantages of which are a higher cost, a larger weight, not wear-resisting and the like) to increase the torque to an extent in some cases, and then disadvantages of using the reducer can be overcome. Such an electric machine is applied to the robot directly driven by the electric machine to increase flexibility of controlling the robot and simplify design thereof as a whole.

Because the bushing layer can be made of the above materials and said materials have advantages of a light weight, resistant to friction, a smooth surface. Therefore, with respect to the bearings in the prior art, the bushing layer made of these materials can relatively reduce wearing and friction during movement between the rotor and the stator, and the bushing layer made of these materials enable the electric machine to have a less light weight. Further, the electric machine can bear a larger load under the same torque by reducing the weight of the electric machine which well facilitating the electric machine to drive the robot directly.

As can be seen from the above, the present disclosure provides a electric machine, wherein a bushing layer is disposed between the stator component and the rotor component and a thickness of the bushing layer is slightly less than the air gap, which results in the following technical effects:

1. Because the bushing layer is disposed between opposite surfaces of the stator component and the rotor component and the thickness of the bushing layer is slightly less than the gap, the gap between the stator component and the rotor component can be defined while ensuring movement of the rotor with respect to the stator, and the magnetic gap produced between the stator component and the rotor component cannot be influenced, so that the gap between the stator component and the rotor component can be defined by a simple structure of the electric machine, which reduces weight of the electric machine. Meanwhile, because use of this simple structure, a very little gap between the stator component and the rotor component can be defined without adding other members. Therefore, the present disclosure is applied to an electric machine of a little gap, the weight of the electric machine can be reduced.

2. Because the bushing layer is fixed to the corresponding stator component or the corresponding rotor component which ensures the bushing layer is at least fixed on the stator component or the rotor component, friction of the stator component or the rotor component with the respective side surface of the corresponding fixed bushing layer can be relatively reduced during movement of the rotor.

3. Because the bushing layer can be made of at least one selected from the group consisting of Teflon, epoxy resin, nickel, or any material a surface of which is coated with epoxy resin; or the bushing layer can be made of a material such as the relevant metal or alloy directly electroplated on the rotor component and/or the rotor component and the like; or the bushing layer can be made of combination of the above materials. The above materials have the following advantages: a light weight, resistant to friction, a smooth surface. Therefore, with respect to the bearings in the prior art, the bushing layer made of these materials can relatively reduce wearing and friction during movement between the rotor and the stator, and the bushing layer made of these materials enable the electric machine to have a less light weight.

4. By using the electric machine provided by the present disclosure, because the gap is reduced, the torque can be correspondingly increased in certain electric machine structures, which can replace the reducer (disadvantages of which are a higher cost, a larger weight, not wear-resisting and the like) to increase the torque to an extent in some cases, and then disadvantages of using the reducer can be overcome. Such an electric machine is applied to the robot, and it can be easy to drive the robot directly by the electric machine.

5. Because the bushing layer can be made of at least one selected from the group consisting of Teflon, epoxy resin, nickel, or any material a surface of which is coated with epoxy resin; or the bushing layer can be made of a material such as the relevant metal or alloy directly electroplated on the rotor component and/or the rotor component and the like; or the bushing layer can be made of combination of the above materials. The above materials have the following advantages: a light weight, resistant to friction, a smooth surface. Therefore, with respect to the bearings in the prior art, the bushing layer made of these materials can relatively reduce wearing and friction during movement between the rotor and the stator, and the bushing layer made of these materials enable the electric machine to have a less light weight. Further, the electric machine can bear a larger load under the same torque by reducing the weight of the electric machine which well facilitating the electric machine to drive the robot directly.

Although the disclosure is illustrated and described herein with reference to specific embodiments, the disclosure is not intended to be limited to the details shown. Rather, various modifications may be made in the details within the scope and range of equivalents of the claims and without departing from the disclosure.

What is claimed is:

1. An electric machine, comprising:
a stator component;
a rotor component, wherein a gap is formed between the stator component and the rotor component; and
a bushing layer disposed between opposite surfaces of the stator component and the rotor component and configured to define the gap, wherein a thickness of the bushing layer is less than the gap.

2. The electric machine of claim 1, wherein the bushing layer is fixed to the stator component or the rotor component.

3. The electric machine of claim 1, wherein the bushing layer comprises an integral first bushing.

4. The electric machine of claim 3, wherein the integral first bushing has two side surfaces, and one of the side surfaces is fixed to the corresponding stator component or the corresponding rotor component.

5. The electric machine of claim 4, wherein the side surface fixed to the corresponding stator component or the corresponding rotor component is fixed by adhesion, electroplating, a snap-fit connection or a fixing member.

6. The electric machine of claim 1, wherein the bushing layer comprises at least two second bushings radially arranged in parallel.

7. The electric machine of claim 6, wherein a side surface of two second bushings located at two ends of the bushing layer is fixed to the corresponding stator component or the corresponding rotor component.

8. The electric machine of claim 7, wherein the side surface fixed to the corresponding stator component or the corresponding rotor component is fixed by adhesion, electroplating, a snap-fit connection or a fixing member.

9. The electric machine of claim 1, wherein the bushing layer comprises at least two distributed third bushings.

10. The electric machine of claim 9, wherein each of the two distributed third bushing has two side surfaces, and one of the two side surfaces is fixed to the corresponding stator component or the corresponding rotor component.

11. The electric machine of claim 10, wherein the side surface fixed to the corresponding stator component or the corresponding rotor component is fixed by adhesion, electroplating, a snap-fit connection or a fixing member.

12. The electric machine of claim 1, wherein the bushing layer is made of at least one selected from the group consisting of Teflon, epoxy resin, nickel, electroplatable metal or alloy coated with epoxy resin, or combination thereof.

13. The electric machine of claim 2, wherein the bushing layer is fixed to the stator component or the rotor component by adhesion, electroplating, a snap-fit connection or a fixing member.

14. An apparatus, comprising:
an electric machine, comprising:
a stator component;
a rotor component, wherein a gap is formed between the stator component and the rotor component; and
a bushing layer disposed between opposite surfaces of the stator component and the rotor component and configured to define the gap, wherein a thickness of the bushing layer is less than the gap.

15. The apparatus of claim 14, wherein the apparatus is a robot driven directly by the electric machine.
